(19) United States
(12) Patent Application Publication
(10) Pub. No.: US 2008/0315552 A1
(43) Pub. Date: Dec. 25, 2008

(54) Dual-function bicycle seat post assembly

(76) Inventor: Mei-Yen Hsu, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/812,391

(22) Filed: Jun. 19, 2007

(51) Int. Cl. B62K 19/00

(52) U.S. Cl. 280/283

(57) ABSTRACT

A bicycle seat post assembly includes an outer tube with an inner tube movably inserted thereto, the top end of the inner tube is connected with a seat. The inner tube has a passage defined longitudinally therethrough and a valve is connected to the lower end of the inner tube. A connection member is connected to the lower end of the outer tube and a seal member or an output tube is selectably connected to the connection member. The seal member seals the lower end of the outer tube to form a interior space in the outer tube filled with pressurized air when the bicycle seat assembly is a shock absorbing seat post assembly. The output tube is connected to the connection member to communicate with the longitudinal passage of the outer tube when the seat post assembly is used as a tire pump by reciprocating the inner tube.

### FIELD OF THE INVENTION

The present invention relates to a bicycle seat post assembly which provides shock absorbing feature when a seal member is connected to a lower end of the outer tube, and can be used as a pump when removing the seal member.

### BACKGROUND OF THE INVENTION

A conventional bicycle seat post is simply a rod connected with the seat and can be inserted into the seat tube of the bicycle frame. Some manufacturers insert springs in the seat tube to provide shock absorbing feature for the seat. However, the seat post cannot contact the spring if the seat is adjusted to be located at a higher position. Some manufacturers equip the seat tube with a space filled with pressurized air which can be compressible so as to absorb shocks.

Besides, a tire pump is needed when the tire flats and the tire pump has to be positioned at a rack fixed on the bicycle frame. The tire pump increases the weight of the bicycle and some users do not like to carry the tire pump which is seldom used.

The present invention intends to provide a bicycle seat post assembly which provides shock absorbing feature when being used in normal status, and can also be used as a tire pump when needed.

### SUMMARY OF THE INVENTION

The present invention relates to a bicycle seat post assembly which comprises an outer tube having a longitudinal passage defined therethrough and a connection member is connected to a lower end of the outer tube so as to be selectably connected with a seal member or an output tube. An inner tube is movably inserted in the outer tube and includes a first passage defined longitudinally therethrough. A top end of the inner tube extends through the top end of the outer tube and a one-way valve is connected to a lower end of the inner tube. A seat support is connected to the top end of the inner tube and a seat is connected to the seat support. When the seal member is connected to the connection member, it seals the lower end of the outer tube and the seat post assembly is a shock absorbing seat post assembly. When the seat post assembly is used as a tire pump, the output tube is connected to the connection member and communicates with the longitudinal passage of the outer tube.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the seat post assembly of the present invention;

FIG. 2 is a cross sectional view to show the seat post assembly of the present invention;

FIG. 3 is a cross sectional view to show when the seat post assembly is used as a shock absorbing seat post assembly, and

FIG. 4 is a cross sectional view to show when the seat post assembly is used as a tire pump.

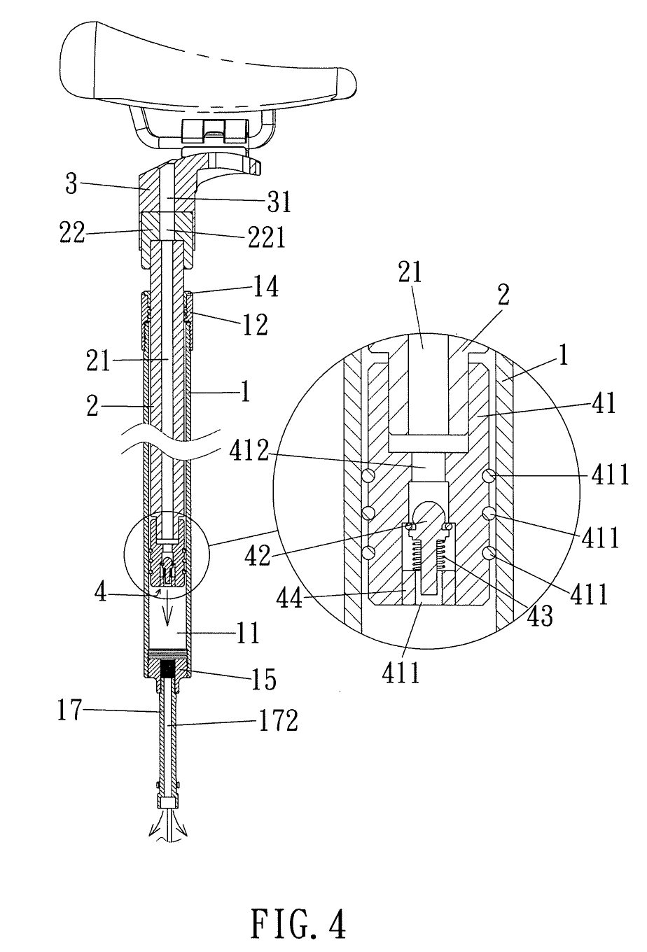

### DETAILED DESCRIPTION OF THE PREFERRED EMBODIMENT

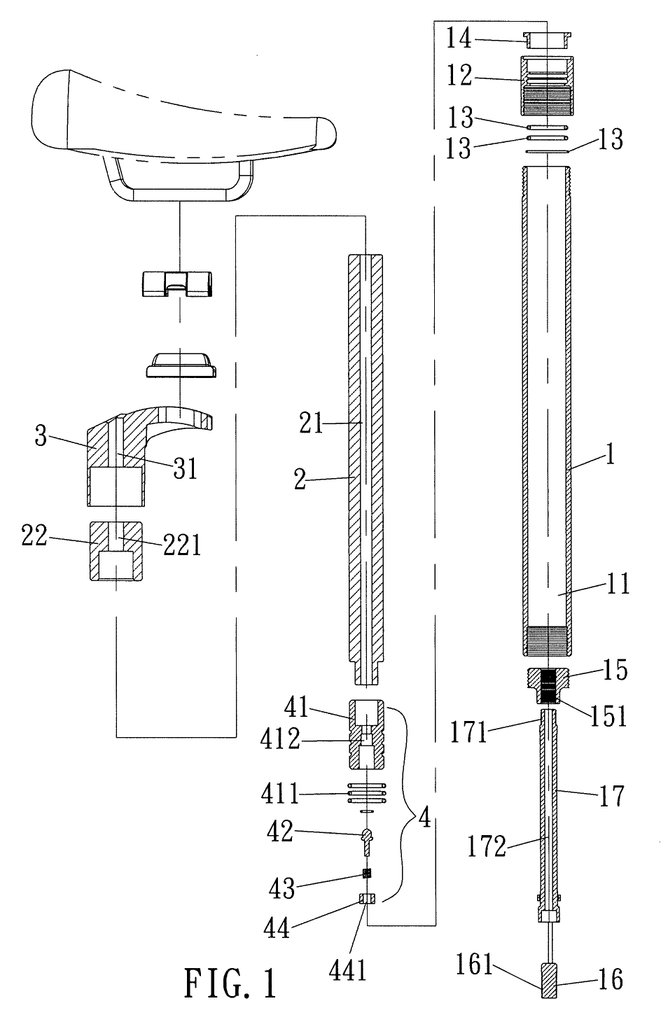

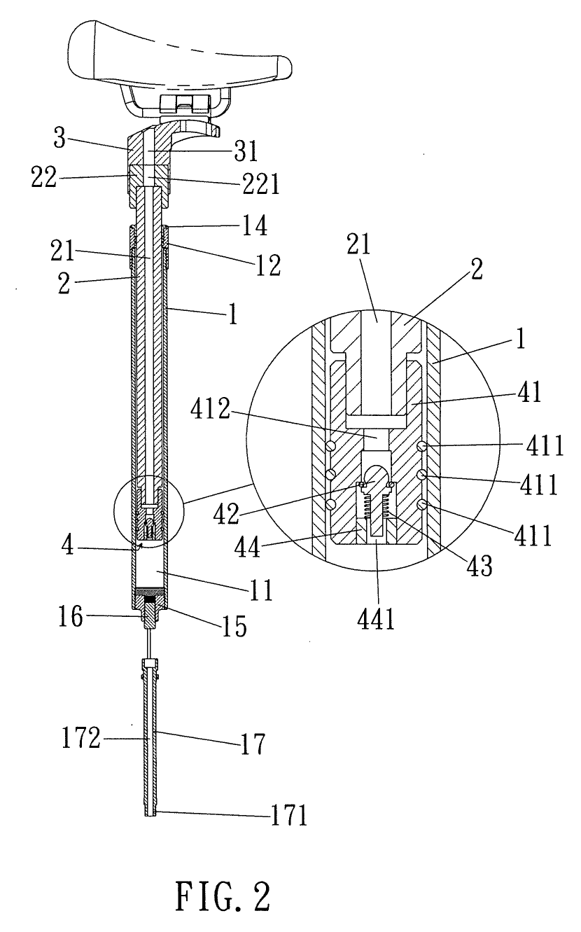

Referring to FIGS. 1 and 2, the seat post assembly of the present invention comprises an outer tube 1 having a longitudinal passage defined therethrough and a first top cap 12 is connected to a top end of the outer tube 1. A plurality of seal rings 13 are located between an inner periphery of the first top cap 12 and an outer periphery of the outer tube 1. A bush 14 is inserted in the first top cap 12. A connection member 15 is threadedly connected to a lower end of the outer tube 1 and includes an inner threaded passage 151.

An inner tube 2 is movably inserted in the outer tube 1 and includes a first passage 21 defined longitudinally therethrough. A top end of the inner tube 2 extends through the bush 14 in the top cap 12 on the top end of the outer tube 1 and a second top cap 22 is connected to the top end of the inner tube 2. A seat support 3 is connected to the top cap 22 and a seat is connected to the seat support 3. A one-way valve 4 is connected to a lower end of the inner tube 2 and includes a tubular body 41 connected to the lower end of the inner tube 2 and a plurality of seal rings 411 are mounted to the tubular body 41. A stepped hole 412 is defined in the tubular body 41 and an end member 44 is connected to a lower end of the tubular body 41. The end member 44 includes a hole 441 defined longitudinally therethrough. A seal member 42 and a spring 43 are received in the tubular body 41 and the seal member 42 is biased by the spring 43 which is located between a head of the seal member 42 and the end member 44. The head of the seal member 42 removably seals the stepped hole 412. The seat support 3 includes an inlet hole 31 which is in communication with the through hole 221 of the second top cap 22 and the first passage 21 of the inner tube 2.

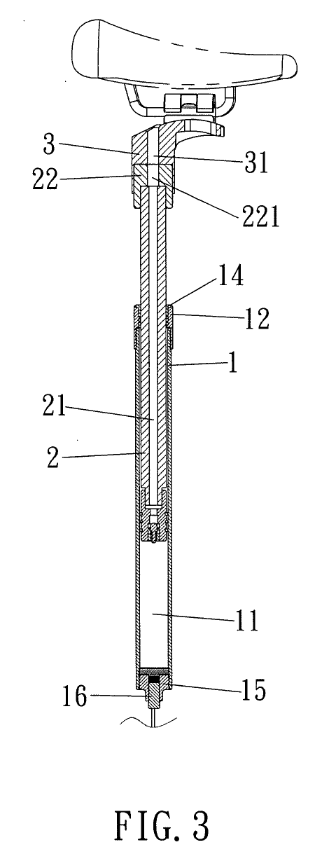

A seal member 16 and an output tube 17 are selectably connected to the connection member 15 to have different functions. As shown in FIG. 3, the seal member 16 includes an outer threaded section 161 which is engaged with the inner threaded passage 151 of the connection member 15 and seals the lower end of the outer tube 1. Therefore, there is an interior space 11 defined between the lower end of the inner tube 2 and the seal member 16. The interior space 11 is filled with air which is sealed in the interior space 11 and compressible so that shocks can be absorbed when the inner tube 2 together with the seat move downward relative to the seat tube of the bicycle frame to compress the air in the interior space 11.

When the output tube 17 is connected to the connection member 15 by connecting an outer threaded section 171 of the output tube 17 with the inner threaded passage 151 of the connection member 15, the second passage 172 defined through the output tube 17 communicates with the longitudinal passage of the outer tube 1. Therefore, when the seat post assembly is used as a tire pump, the user pulls the seat post assembly out from the seat tube of the bicycle frame, and move the inner tube 2 up and down to push air in the outer tube 1 out from the output tube 17 to inflate tires.

The seat post assembly includes two different functions and no extra parts are connected to the outside of the bicycle frame.

While we have shown and described the embodiment in accordance with the present invention, it should be clear to those skilled in the art that further embodiments may be made without departing from the scope of the present invention.

What is claimed is:

1. A bicycle seat post assembly comprising:
an outer tube having a longitudinal passage defined therethrough and a first top cap is connected to a top end of the outer tube, a connection member connected to a lower end of the outer tube, a seal member and an output tube selectably connected to the connection member, the seal member sealing the lower end of the outer tube when the bicycle seat assembly is a shock absorbing seat post assembly, the output tube connected to the connection member to communicate with the longitudinal passage of the outer tube when the seat post assembly is used as a tire pump;
an inner tube movably inserted in the outer tube and including a first passage defined longitudinally therethrough, a top end of the inner tube extending through the top cap on the top end of the outer tube and a one-way valve connected to a lower end of the inner tube, and
a seat support connected to the top end of the inner tube and a seat connected to the seat support.

2. The assembly as claimed in claim 1, wherein a plurality of seal rings are located between an inner periphery of the first top cap and an outer periphery of the outer tube.

3. The assembly as claimed in claim 1, wherein a bush is inserted in the first top cap and the inner tube movably extends through the bush.

4. The assembly as claimed in claim 1, the seat support includes an inlet hole which is in communication with the first passage of the inner tube.

5. The assembly as claimed in claim 4, wherein a second top cap is connected to the top end of the inner tube and includes a through hole which communicates with the inlet hole and the first passage.

6. The assembly as claimed in claim 1, wherein the one-way valve includes a tubular body connected to the lower end of the inner tube and a plurality of seal rings are mounted to the tubular body, a stepped hole is defined in the tubular body and an end member is connected to a lower end of the tubular body, the end member includes a hole defined longitudinally therethrough, a seal member and a spring received in the tubular body and the seal member is biased by the spring which is located between a head of the seal member and the end member, the head of the seal member removably seals the stepped hole.

7. The assembly as claimed in claim 1, wherein the connection member includes an inner threaded passage and the seal member includes an outer threaded section which is engaged with the inner threaded passage.

8. The assembly as claimed in claim 1, wherein the connection member includes an inner threaded passage and the output tube includes an outer threaded section which is engaged with the inner threaded passage.
